(19) United States
(12) Patent Application Publication
(10) Pub. No.: US 2007/0277524 A1
(43) Pub. Date: Dec. 6, 2007

(54) Engine And An Apparatus For Providing Forced Aspiration To An Engine

(75) Inventor: Anthony Osborne Dye, Girton, Cambridge (GB)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: EPICAM LIMITED, Linton, Cambridgeshire (GB)

(21) Appl. No.: 10/589,433

(22) PCT Filed: Feb. 18, 2005
(86) PCT No.: PCT/GB05/00622

§ 371 Date: Jun. 13, 2007

(30) Foreign Application Priority Data
Feb. 19, 2004 (GB) 0403718.0

(51) Int. Cl. F02B 41/10; F02B 37/12

(52) U.S. Cl. 60/602; 60/598

(57) ABSTRACT

The invention provides an apparatus for providing forced aspiration to an internal combustion engine. The apparatus includes a first displacement device for being driven by exhaust gas from an internal combustion engine to which the apparatus is in use mounted and, a second displacement device operable to compress combustion gas for provision to an engine to which the apparatus is in use mounted. The first and second displacement devices are coupled such that when in use the first displacement device is driven and causes the second displacement device to operate.

The present invention relates to an engine and an apparatus for providing forced aspiration to an engine.

An internal combustion engine has one or more combustion chambers for the combustion of fuel. Each of the combustion chambers is associated with a swept volume chamber in which a volume is swept by a member to compress an air/fuel mixture. One example of such an engine is a piston engine in which in use, air is introduced to a cylinder of the piston engine together with fuel. In the case of a piston engine, the cylinder is the swept volume chamber. The air/fuel mixture is compressed by a piston and then ignited within the combustion chamber, by a spark plug in the case of a petrol engine or by compression in the case of a diesel engine, causing expansion of combustion gases. Expansion of the combustion gases forces the piston to undergo a power stroke. After the power stroke, the combustion gases are vented via an exhaust to the atmosphere.

It is desirable to maximise the power density from a given size of engine, the power density being the power obtained from a given swept volume within the engine cylinders.

In some literature, the term “supercharger” is used to mean a device that uses power from an engine's output shaft to drive a compressor to provide air at higher than atmospheric pressure to the swept volume chamber of an internal combustion engine. In the present specification the term “supercharger” will be given its alternative and more generic meaning of any device that in use functions to increase the pressure of air provided to the swept volume chamber of an internal combustion engine, i.e. provides forced aspiration.

In the present specification the term “turbocharger” means a device that uses energy recovered by a turbine from the exhaust gas to drive a compressor to provide air at higher than atmospheric pressure to the swept volume chamber of an internal combustion engine.

Turbocharging, i.e. the use of a turbocharger, has become the predominant technique for increasing the power density of piston engines. The popularity of a turbocharger is due to its ability to provide additional compression of combustion gases to boost intake charge pressure with no loss of fuel efficiency. A conventional turbocharger has a turbine arranged in an engine's exhaust manifold. The turbine is in some way coupled to a compressor and arranged such that on rotation of the turbine, the compressor operates to compress intake air being passed to the combustion chambers. In other words, energy is used which is recovered from the expanding exhaust gas as it passes through the exhaust manifold of the engine. Without a turbocharger, this energy would all be wasted.

A conventional turbocharger has a radial flow turbine arranged within the exhaust manifold of the engine. As exhaust gas passes through the exhaust manifold, the turbine is caused to rotate and drive the associated compressor. Radial flow turbines are only effective over a limited range of rotational speeds, typically above a threshold such as 50,000 rpm. Thus, it is necessary for the engine to be operating above a minimum critical speed in order that sufficient exhaust gas flow is present to accelerate the radial flow turbine into its operating speed range. No beneficial effect is possible below this critical speed threshold and indeed below this threshold no significant improvement in engine performance is obtained, beyond that achievable by natural aspiration.

Radial flow turbines also have upper limits in the rotational speeds at which they operate effectively. Accordingly, once the radial flow turbine is rotating at or above the threshold rotational speed referred to above, any excess exhaust gas pressure has to be diverted away from the radial flow turbine via a waste gate to keep the turbine operating within its effective range.

A further problem with conventional turbochargers is known as “turbo lag”. This is the name given to a delay between an increase in engine speed or load and a corresponding increase in operation of an associated turbocharger. Its occurrence is due to the fact that the radial flow turbine used in conventional turbochargers rotates independently of the engine. As the engine speed or load increases, the exhaust gas flow increases but this does not cause an immediate increase in turbocharge effect as first the turbine must accelerate and then the associated compressor must operate before a turbo boost effect is achieved.

An alternative type of device for increasing the pressure of air delivered to an engine's cylinders comprises a belt connected to the engine output shaft, referred to hereinafter as the engine crank shaft, and also connected to a compressor. Rotation of the engine crankshaft turns the belt, which in turn drives the compressor. The compressor in turn provides a boost in the pressure of air provided to the engine cylinders. Since the belt obtains power directly from the engine 11 crank shaft, the engine efficiency is likely to be adversely affected.

According to a first aspect of the present invention, there is provided an apparatus for providing forced aspiration to an internal combustion engine, the apparatus comprising: a first displacement device for being driven by exhaust gas from an internal combustion engine to which the apparatus is in use mounted; and, a second displacement device operable to compress combustion gas for provision to an engine to which the apparatus is in use mounted; the first and second displacement devices being coupled such that when in use the first displacement device is driven and causes the second displacement device to operate.

The invention provides an apparatus for providing forced aspiration to an internal combustion engine. The apparatus has first and second displacement devices coupled to each other. The first displacement device is arranged such that in use it is driven by exhaust gas. The second displacement device is arranged such that in use, when the first displacement device is driven, the second displacement device operates. As a consequence of the fact that first and second displacement devices are used in the apparatus, the apparatus can achieve effective performance throughout the operating speed range of an engine on which in use the apparatus is mounted. This is because the devices are displacement devices, like the cylinders or more generally the swept volume chambers of an internal combustion engine. There is no requirement for a high minimum exhaust gas flow rate until the apparatus can operate as in the case of a conventional turbocharger.

The apparatus may, in use, be connected to any suitable type of engine, such as, amongst others, a two or four stroke diesel engine; two or four stroke petrol or gas fuelled, spark ignition engine; or a Wankel or other type of engine with Otto or diesel thermodynamic cycle; and an engine as disclosed in International patent application number WO-A-91/06747, the entire contents of which are hereby incorporated by reference. The apparatus is suitable for connection to any type of engine having swept volume chambers that can operate without any or only limited variable volume capacity.

Preferably, at least one of the first and second displacement devices comprises a lobed rotor and a recessed rotor arranged in a predefined configuration, such that on rotation of the lobed rotor and the recessed rotor, a lobe from the lobed rotor enters a recess from the recessed rotor to define a variable volume chamber therebetween for compression or expansion of a working gas.

A preferred displacement device having a lobed and recessed motor is described and shown generally both in International patent application number WO-A-91/06747 and US-B1-6176695. However, other suitable displacement devices may be used. Examples include a roots blower and a screw compressor.

According to a second aspect of the present invention there is provided an internal combustion engine, the engine comprising: one or more swept volume chambers for receiving a fuel and air mixture; an apparatus for providing forced aspiration to the swept volume chambers, the apparatus comprising an expander to receive exhaust gas from the engine and a compressor driven by the expander to compress air for provision to the one or more swept volume chambers, wherein the expander and the compressor are each displacement devices.

According to a third aspect of the present invention there is provided an engine having an apparatus mounted thereon, the apparatus being for providing forced aspiration to the engine, the apparatus comprising: an expander to be driven by exhaust gas from one or more swept volume chambers of the engine; and, a compressor to be driven by the expander to compress air for provision to the one or more swept volume chambers of the engine, wherein a connection is provided between the apparatus and the engine output shaft to enable, when insufficient exhaust gas to drive the expander is generated by the engine, power to be taken from the engine to drive the compressor and when sufficient exhaust gas is generated, excess power not needed to drive the compressor is provided to the engine output shaft.

Examples of embodiments of the present invention will now be described in detail with reference to the accompanying drawings, in which:

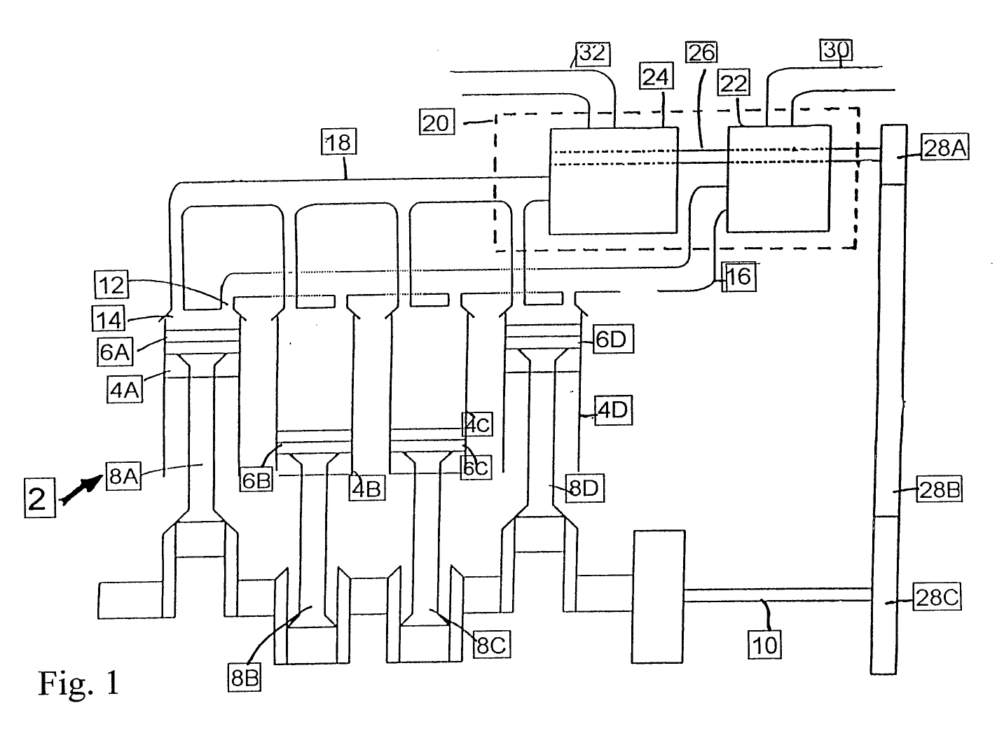

FIG. 1 shows a schematic diagram of an engine according to an example of an embodiment of the present invention;

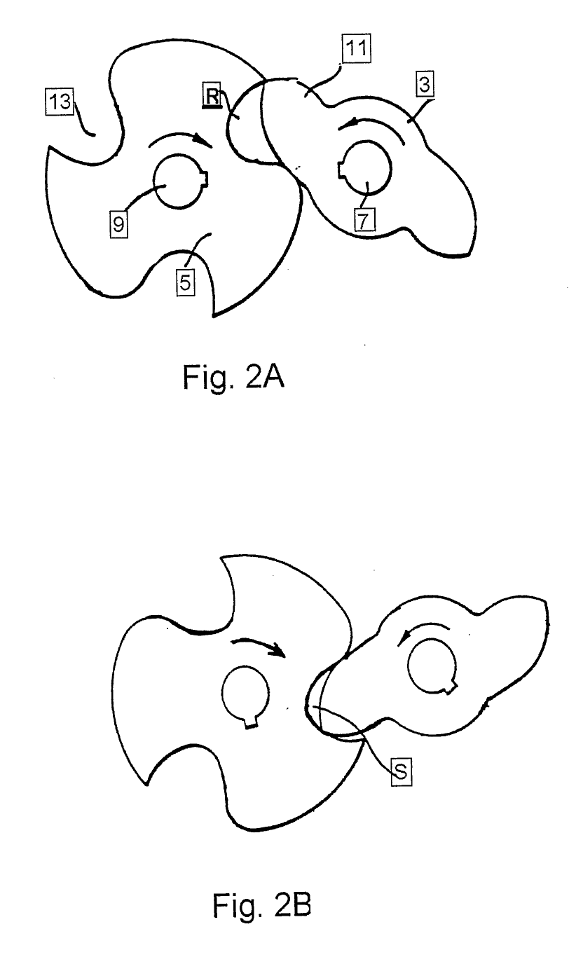

FIG. 2A shows an example of a compressor for use in an apparatus according to an embodiment of the present invention;

FIG. 2B shows an example of an expander for use in an apparatus according to an embodiment of the present invention;

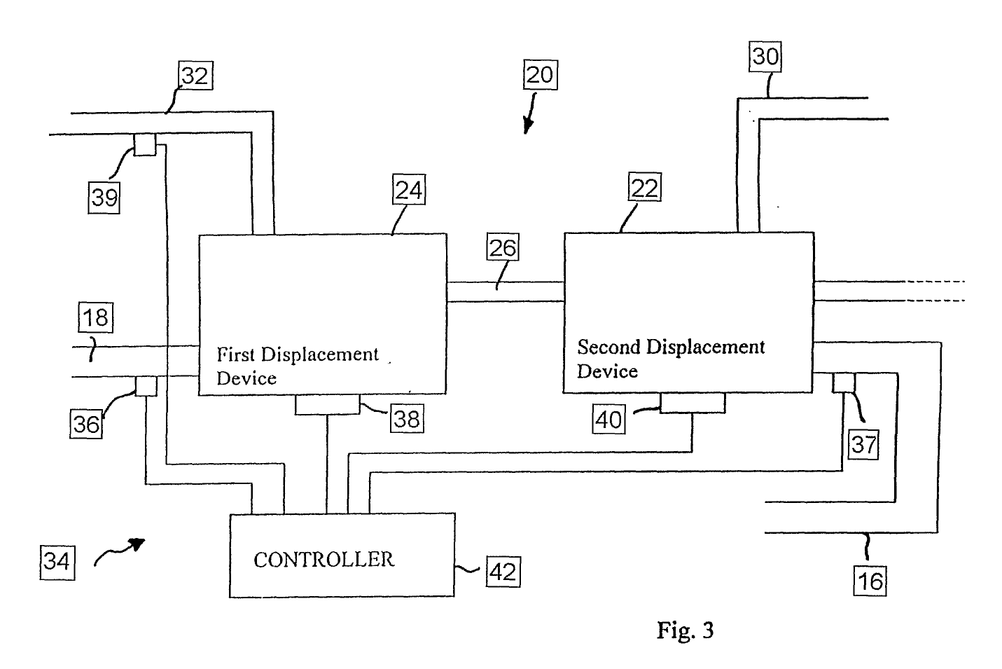

FIG. 3 shows a schematic block diagram of an example of a control system for use in the engine of FIG. 1;

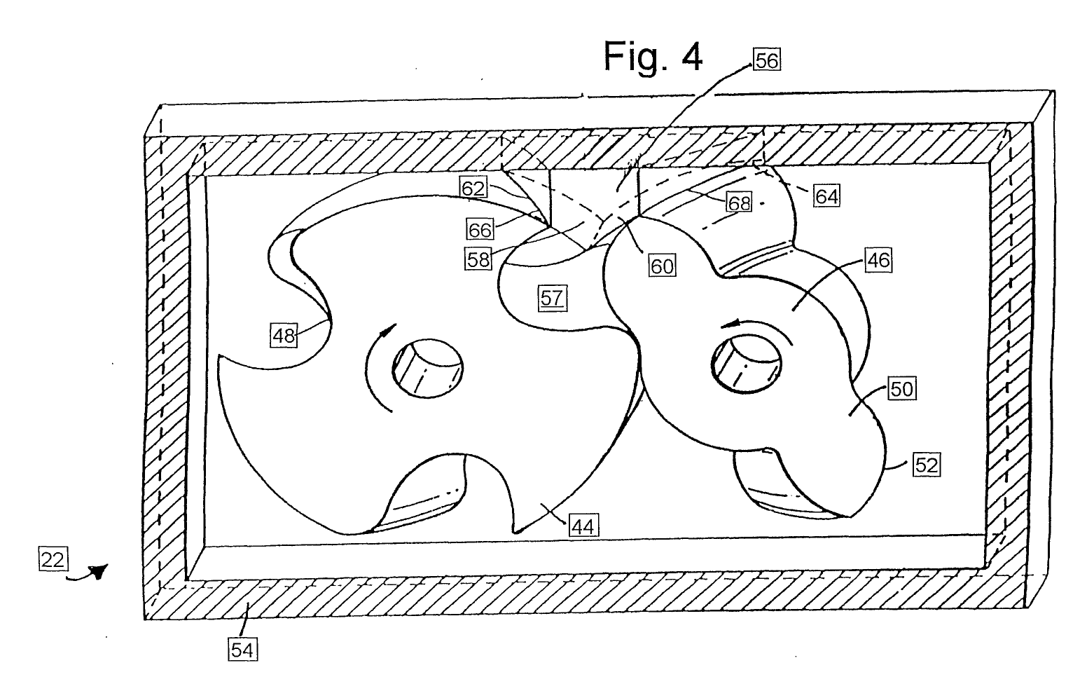

FIG. 4 shows a projected end view of a compressor suitable for use in an apparatus according to an embodiment of the present invention; and,

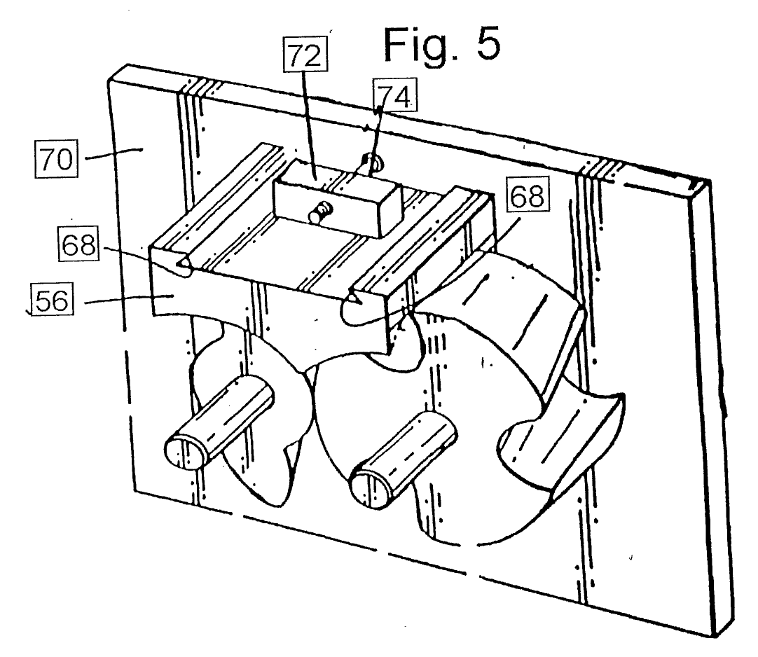

FIG. 5 shows a perspective view from above of the compressor in FIG. 4.

FIG. 1 shows a schematic representation of an example of an engine 2 according to an embodiment of the present invention. The engine 2 comprises a number of cylinders 4A to 4D each having a piston 6A to 6D slideably arranged therein.

A respective connecting rod 8A to 8D is provided to connect each of the pistons 6A to 6D to a common output shaft 10, referred to hereinafter as the engine crank shaft 10. Each cylinder 4A to 4D has an opening 12 for receiving air via an intake manifold 16. Each cylinder 4A to 4D also has an exhaust opening 14 to provide an outlet for exhaust gases generated in the respective cylinder 4A to 4D. An exhaust manifold 18 is provided to provide a route for exhaust gases from the cylinder 4A to 4D to an associated exhaust system discharge conduit 32.

A fuel input is also provided to each of the cylinder 4A to 4D. Any suitable type of fuel input system may be used. The type used depends for example on the type of engine. The fuel input system is not shown in FIG. 1.

The engine is a conventional four-stroke internal combustion engine and a description of its operation will therefore not be included.

An apparatus 20 is provided to receive exhaust gases via the exhaust manifold 18 and provide compressed air to the intake manifold 16. In other words, the apparatus is a supercharger as defined generically above as being a device capable of providing an engine with forced aspiration.

The apparatus 20 comprises a compressor 22 and an expander 24 connected to each other in such a way that when the expander is driven by the exhaust gas, the compressor 22 is caused to operate. In the particular example shown the connection between the expander and the compressor is via a common drive shaft 26.

The apparatus 20 also includes an intake air supply duct 30 for providing a supply of air to the compressor 22. The exhaust system discharge conduit 32 provides an outlet for exhaust gas from the expander 24.

In the example shown in FIG. 1, the common drive shaft 26 is also coupled to the engine drive shaft 10 via a direct drive coupling 28 at a desired fixed speed ratio. The direct drive coupling is made up of a number of gears 28A to 28C. As will be explained below, provision of a direct drive coupling enables a drive to be taken from the engine drive shaft 10 to drive the compressor if the amount of exhaust gas generated by the engine is insufficient to provide a desired amount of compression by compressor 22.

An alternative indirect coupling between the apparatus 20 and the engine drive shaft 10 could be provided such as via an electric motor/generator with an intermediate power source.

The compressor 22 and expander 24 are selected such that the primary characteristics of both devices are those of displacement devices so that their performance and fluid throughput is directly related to rotational speed, as is the case with piston engines. Their respective speeds of rotation are related to that of the engine since the pistons within the engine are also displacement devices. Irrespective of the speed of the engine, if the engine is operating, exhaust gas will be produced. Since the expander is a displacement device, any exhaust gas that is produced will cause it to operate and consequently cause the compressor to operate.

This provides the advantage that the compressor 22 and expander 24 can achieve effective performance throughout the operating speed range of the engine. This contrasts with a conventional turbocharger which is not able to operate at all speeds of operation of the engine. As explained above, a turbocharger will not provide any increase in performance of an engine if insufficient exhaust gas flow is being generated.

Examples of displacement devices include roots blowers and screw compressors. However, a most preferred type of expander and compressor for use in the apparatus is as shown in and described in detail in International patent application having publication No. WO-A-91/067474. The contents of this disclosure are incorporated, in their entirety, herein by reference.

FIG. 2A shows an end view of a compressor of this type. The compressor has a lobed rotor 3 and a recessed rotor 5 arranged for rotation on respective shafts 7 and 9. As the lobed rotor 3 and the recessed rotor 5 rotate on their respective shafts 7 and 9, a lobe 11 from the lobed rotor 3 enters a recess 13 from the recessed rotor 5. A transient chamber R of decreasing volume is defined between the lobe 11 and the recess 13. This transient chamber R is where a working gas (air in this case) is compressed. FIG. 2B shows an example of an expander for use in an apparatus according to an example of an embodiment of the present invention. In this case it will be appreciated that as the rotors continue to rotate in the directions as indicated by arrows in FIG. 2B (lobed rotor anti-clockwise, recessed rotor clockwise), transient chamber S will increase in volume.

In the case of such lobed and recessed rotors being used, the common shaft 26 of the apparatus 20 referred to above is preferably connected to the lobe rotor shaft of each device. This is because the lobe rotor shaft operates at a higher speed (in this example by a ratio of 3:2) compared with that of the recessed rotor.

The operation and function of the engine 2 and apparatus 20 will now be described in more detail with reference to FIGS. 1 and 3. For the purposes of this description it will be assumed that the expander and compressor are of the type shown in FIGS. 2A and 2B respectively.

The expander 24 is driven by the exhaust gases received by the expander 24 from the exhaust manifold 18. As the exhaust gases pass through the exhaust manifold and into the expander 24, the exhaust gases 18 expand, causing the rotors within expander 24 to rotate. This in turn causes a rotation of lobe rotor shaft 26 and a consequent rotation of the rotors provided within compressor 22. Accordingly, the air supplied to combustion chambers 4 from compressor 22 via intake manifold 16 is compressed.

In this example, the compressor 22 and expander 24 are linked together by the common drive shaft 26. Indeed, in this example the shaft 26 actually connects the lobe rotor shafts of both devices 22 and 24. Any other suitable coupling between the expander and the compressor may be used such that when the expander is driven by exhaust gas, the expander in turn drives the compressor 22. Examples of suitable couplings include, gears, a belt, electric drive via a generator and motor etc.

As explained above, in one example, a direct drive coupling 28 is provided between the drive shaft 26 of the apparatus 20 and the drive shaft 10 of the engine 2. Thus, if the engine 2 is operated such that a minimum level of exhaust gas expansion occurs, then the expander 24 is able to recover this energy and deliver a predetermined boost pressure in the intake air via the compressor 22. If the engine loading increases beyond this minimum, then increased power will be available from the common shaft 26. If an excess of power is produced by the apparatus, over and above that required to compress the intake air, then the surplus is provided from the common shaft 26 to the engine output shaft 10 via the direct drive coupling 28. Accordingly, a direct additional contribution to engine power output is provided. This provides an improvement in performance and fuel economy compared with an equivalent turbocharged engine. Conversely, if insufficient exhaust gas is generated to drive the expander and cause the compressor to operate, a drive to the compressor can be taken from the engine output shaft via the coupling 28.

FIG. 3 shows in more detail the apparatus 20 as shown in and described with reference to FIG. 1, together with a control system. Components are numbered in the same way as the corresponding components shown in and described with reference to FIG. 1. In addition to these, the apparatus 20 has a control system 34 associated therewith.

The control system 34 has a pressure sensor 36 and 37 connected to each of the exhaust manifold 18 and inlet manifold 16 respectively, and movable wall units 38 and 40 connected to the expander 24 and compressor 22 respectively. Each of the pressure sensors 36 and 37 and the units 38 and 40 are connected to a controller 42. The controller 42 may be embodied by a microprocessor or any other such suitable device. Optionally, a further pressure sensor 39 may be provided on the exhaust system discharge conduit 32.

The units 38 and 40 serve to provide control of the maximum possible volume of the transient chambers within both the compressor 22 and the expander 24. As will be explained below, in normal use, transient chambers are defined within the compressor 22 and the expander 24. The transient chambers have volumes that vary cyclically. For example, in the case of a compressor, initially the transient chamber is relatively large. In operation, an amount of air is received into this relatively large chamber. As the compressor operates, the volume of the transient chamber reduces thereby compressing the air within the transient chamber. The units 38 and 40 provide control of the maximum possible volume of the transient chamber in each of the compressor and expander. A suitable system for providing such control is disclosed in US-B-6176695, the entire contents of which are incorporated herein by reference.

An example of a suitable system for providing control of the maximum possible volume of the transient chambers in each of the expander and compressor will be described below with reference to FIGS. 4 and 5. Generally, in use the pressure sensor 36 arranged on the exhaust manifold 18 is arranged to provide a variable signal to controller 42, the signal being dependent on pressure within the exhaust manifold 18. Similarly, the pressure sensor 38 arranged on the exhaust system discharge conduit 32 is arranged to provide a variable signal to controller 42, the signal being dependent on pressure within the conduit 32.

The processor 42 is arranged to provide control signals to units 38 and 40 in dependence on signals received from any or both of pressure sensors 36 and 37 and other engine management control data. As will be explained below, the signals provided by processor 42 to units 38 and 40 serve to cause the units to respond in a manner so as to vary the maximum possible volume of the transient chambers within the expander 24 and compressor 22. This enables accurate control of pressure within the inlet manifold 16 to be provided.

Active control of the maximum possible volume of the transient chamber within the expander 24 is achieved with a feedback monitoring and control system. In one embodiment the feedback monitoring and control system continually adjusts the maximum possible volume of the transient chamber within the expander 24 so as to maintain the pressure of the fully expanded fluid (the exhaust gas) as close to ambient pressure as possible. This ensures that when the engine is operating at light load, the limited flow of exhaust gas will not be over-expanded, i.e. to a pressure below ambient pressure. This would otherwise require additional load to be obtained from the engine via the coupling 28.

When the engine is operating at full load, the maximum possible volume of the transient chamber can be increased so that all the energy obtainable from the expanding exhaust gas is recovered. The energy obtained over and above that required to drive the compressor 22 is transferred to the engine crank shaft by the coupling 28, as described above. These advantages are available when the apparatus is used on both diesel, petrol and other spark ignited engines.

In the case of an indirect coupling being provided between the apparatus 20 and the engine drive shaft 10, any excess power may be recovered as electricity.

The ability to control the maximum possible volume of the transient chamber within the compressor 22, can provide particularly useful advantages when applied to diesel engines. Control of the maximum possible volume of the transient chamber in the compressor 22 can be applied via an associated engine management system so as to vary the level of increased intake air pressure according to constraints imposed by current operating conditions and desired emissions/economy criteria. Thus, for example, diesel engines operated intermittently at low speed, suffer from comparatively low combustion chamber temperatures which tends to result in premature flame quench and excessive emissions of carbonaceous particulates. In such cases, setting a higher level of boost pressure when the engine is operating under these conditions would result in higher compression temperatures and improved flame propagation with consequently lower particulate emissions.

Control of the maximum possible volume of the transient chamber within the compressor also has substantial advantages for application to spark ignition engines, which are normally throttled. The function of the throttle in controlling air supply to the engine can be achieved by control of the maximum possible volume of the transient chamber in the compressor 22. This means that operating control of the engine from light load to full power with a maximum level of increased intake air pressure can be achieved at any engine speed throughout the operating range of the engine. Indeed, in this case, a throttle device becomes redundant.

One example of a device suitable for providing control of the maximum possible volume of the transient chamber within each of a compressor and an expander will now be described in detail with reference to FIGS. 4 and 5. FIG. 4 shows an end projection of an example of a device suitable for use as the compressor 22 shown in any of FIGS. 1 to 3. A device that functions as an expander is not shown, but it will be appreciated that the shape of the recess and lobe will be as shown in FIG. 2B. The following description is in relation to a compressor.

Two rotors 44 and 46 are provided. The first rotor 44 has three equiangularly spaced recesses at its periphery, each recess being bounded by a curved surface 48 of the first rotor 44. The second rotor 46 has diametrically opposed lobes 50 extending therefrom, each lobe 50 being bounded by a curved surface 52 of the second rotor 46. The lobes 50 fit into and co-operate with the recesses of the first rotor 44. The basic structure of the compressor is similar to that of a rotary device disclosed in WO-A-91/06747, the entire contents of which are incorporated herein by reference.

In the positions of the rotors 44 and 46 shown in FIG. 4, a transient chamber 57 is defined by the curved surface 52 of the second rotor 46, the curved surface 48 of the first rotor 44 and parts of the housing 54. If gas is introduced to the chamber 57 at this stage of the rotation cycle of rotors 44 and 46, it will be compressed as the rotors continue to rotate in the direction of the arrows shown (rotor 44 clockwise, rotor 46 counter-clockwise).

The compressor 22 has a housing 54 arranged to contain the rotors 44 and 46. At least a portion or section 56 of the housing 54 defines arcuate recesses 58 and 60 and is movable parallel to an axis of rotation of rotors 44 and 46. The movable section of the housing 54 has outer edges 62 and 64 which are shaped appropriately to register respectively and simultaneously with the entire axial length of a trailing edge 66 of a recess on the first rotor 44 and the corresponding entire axial length of the tip or leading edge 68 of a lobe on the second rotor 46.

In other words, the movable section of the housing 54 has a wall segment edge 62 which aligns with the whole length of the trailing edge 66 of the first rotor 44 and a wall segment edge 64 which aligns simultaneously with the whole length of the tip or leading edge 68 of a lobe of the second rotor 46. As the movable section 56 of the housing 54 is moved back and forth parallel to the axis of the rotors 44 and 46, the maximum possible volume of the transient chamber 57 defined between the rotors 44, 46 and the arcuate recesses 58 and 60 varies.

An example of one possible embodiment for the units 38 and 40 controllable to vary the maximum possible volume of the transient chambers within each of the expander and compressor will now be described with reference to FIG. 5. The movable section 56 is mounted on a linear bearing 68 for reciprocating movement into and out of the respective recesses in the side wall 70. A control device 72 and 74 is provided to control movement back and forth of the movable section 56. The control device may be a mechanical or electromechanical device or indeed any type of device capable of providing control of the maximum possible volume of the transient chambers within each of the expander and compressor. In the example shown, the control device includes a screw-threaded rod 74 which can be rotated in a correspondingly threaded block 72 fixed to the movable section 56 of the housing 54. Any other suitable control device maybe used.

In use, if the pressure sensor 36 on exhaust manifold 18 (see FIG. 3) detects an increase in pressure within the exhaust manifold 18 a corresponding signal is sent to the controller 42. The controller 42 then sends a correction signal to the control unit 38. Referring now to FIGS. 4 and 5, on receipt of the correction signal from the control unit 38 the screw-threaded rod 74 is caused to rotate and in so doing, causes movement of the threaded bock 72 and the entire movable section 56 fixed thereto. Depending on the direction of rotation of the rod 74, the maximum possible volume of the transient chamber between rotors 44 and 46 can be controlled to increase or decrease. In this example, if there is an excess of pressure within the exhaust manifold 18, the maximum possible volume of transient chamber is increased.

Similarly, if the pressure sensor 37 on inlet manifold 16 detects a change in pressure, a corresponding signal is sent from the pressure sensor 37 to the controller 42. The controller 42 in turn sends a control signal to the control unit 40 associated with the compressor to cause an adjustment in the maximum possible volume of the transient chamber between the rotors in the compressor.

Embodiments of the present invention have been described with particular reference to the example illustrated. However, it will be appreciated that variations and modifications may be made to the examples described within the scope of the present invention.

1. An apparatus for providing forced aspiration to an internal combustion engine, the apparatus comprising:
a first displacement device for being driven by exhaust gas from an internal combustion engine to which the apparatus is in use mounted; and,
a second displacement device operable to compress combustion gas for provision to an engine to which the apparatus is in use mounted;
the first and second displacement devices being coupled such that when in use the first displacement device is driven and causes the second displacement device to operate.

2. An apparatus according to claim 1, in which the first and second displacement devices are coupled by a common shaft of rotation.

3. An apparatus according to claim 1, comprising a drive coupling for coupling the first and/or second displacement device to an engine crank shaft of an engine to which the apparatus is in use mounted.

4. An apparatus according to claim 1, in which at least one of the first and second displacement devices comprises a lobed rotor and a recessed rotor arranged such that on rotation of the lobed rotor and the recessed rotor, a lobe from the lobed rotor enters a recess from the recessed rotor to define a variable volume chamber for respectively compression of exhaust gas or expansion of combustion gas.

5. An apparatus according to claim 4, in which the recess and the lobe extend straight in a direction parallel to the axis of rotation of the corresponding rotor.

6. An apparatus according to claim 4, in which the recess and the lobe extend helically in a direction parallel to the axis of rotation of the corresponding rotor.

7. An apparatus according to claim 4, arranged such that the maximum volume of said variable volume chamber can be controlled.

8. An apparatus according to claim 7, comprising a control device associated with at least one of the first and second displacement devices, the control device being controlled in dependence on a feedback signal generated in dependence on an output of the first displacement device to vary the maximum volume of said variable volume chamber of the at least one of the first and second displacement devices.

9. An apparatus according to claim 8, in which each of the first displacement device and the second displacement device comprises a lobed rotor and a recessed rotor arranged such that on rotation of the lobed rotor and the recessed rotor, a lobe from the lobed rotor enters a recess from the recessed rotor to define a variable volume chamber

10. An apparatus according to claim 9, in which both of the first and second displacement devices has a corresponding control device attached thereto.

11. An apparatus according to claim 8, comprising a pressure sensor mounted on an input to the first displacement device to detect a pressure at the input to the first displacement device and provide a signal in dependence thereon for controlling the or each control device.

12. An apparatus according to claim 8, comprising a pressure sensor mounted on an output of the second displacement device to detect a pressure of combustion gas output from the second displacement device and provide a signal in dependence thereon for controlling the or each control device.

13. An apparatus according to claim 11, comprising a controller arranged to receive the signal from the pressure sensor and provide a control signal to the or each control device to control the maximum possible volume of the respective variable volume chamber.

14. An internal combustion engine, the engine comprising: one or more swept volume chambers for receiving a fuel and air mixture;
an apparatus for providing forced aspiration to the swept volume chambers, the apparatus comprising an expander to receive exhaust gas from the engine and a compressor driven by the expander to compress air for provision to the one or more swept volume chambers, wherein the expander and the compressor are each displacement devices.

15. An engine according to claim 14, wherein the expander and the compressor are connected by a common shaft of rotation.

16. An engine according to claim 14, wherein the common shaft of rotation is connected to an output shaft of the engine in such a way as to be able selectively to provide a driving force to the engine output shaft and to receive a driving force therefrom.

17. An engine having an apparatus mounted thereon, the apparatus being for providing forced aspiration to the engine, the apparatus comprising:
an expander to be driven by exhaust gas from one or more swept volume chambers of the engine; and,
a compressor to be driven by the expander to compress air for provision to the one or more swept volume chambers of the engine,
wherein a connection is provided between the apparatus and the engine output shaft to enable power to be taken from the engine to drive the compressor when insufficient exhaust gas to drive the expander is generated by the engine and to provide power to the engine output shaft from the apparatus when sufficient exhaust gas is generated.

18. An engine according to claim 14, in which at least one of the first and second displacement devices comprises a lobed rotor and a recessed rotor arranged such that on rotation of the lobed rotor and the recessed rotor, a lobe from the lobed rotor enters a recess from the recessed rotor to define a variable volume chamber for respectively compression of exhaust gas or expansion of combustion gas.
